(19) United States
(12) Patent Application Publication
(10) Pub. No.: US 2016/0010708 A1
(43) Pub. Date: Jan. 14, 2016

(54) BRAKE LINING WITH DEVICE FOR REDUCING NOISES

(71) Applicant: FEDERAL-MOGUL BREMSBELAG GMBH, Glinde (DE)

(72) Inventors: Boris Wernitz, Hamburg (DE); Heribert Schumacher, Lueneburg (DE); Andreas Giese, Seevetal (DE)

(73) Assignee: FEDERAL-MOGUL BREMSBELAG GMBH, Glinde (DE)

(21) Appl. No.: 14/795,020

(22) Filed: Jul. 9, 2015

(30) Foreign Application Priority Data
Jul. 10, 2014 (DE) 102014109699.1

(51) Int. Cl. F16D 65/00; F16F 15/00

(52) U.S. Cl. CPC F16D 65/0012; F16F 15/007

(57) ABSTRACT

In order to further improve a brake lining comprising a support body and a friction lining arranged on the support body in such a manner that undesirable noises, in particular undesirable squealing can be avoided or reduced in as cost-effective as possible a manner, it is proposed for the noise reduction by means of a mechanical oscillation on or in the brake lining to arrange an actuator for generating the mechanical oscillation, wherein the actuator can be excited by an electrical signal.

### RELATED APPLICATION

This application claims priority from German Application DE 102014109699.1 filed Jul. 10, 2014.

### DESCRIPTION

The invention relates to a brake lining comprising a support body and a friction lining arranged on the support body.

It is known that brakes installed in vehicles sometimes cause undesirable noises. For example, such undesirable noises can occur during slow travel in particular when a brake lining touches a rotor. This causes vibrations which frequently create high-frequency noises. These undesirable noises are often perceived as squealing.

### PRIOR ART

In order to avoid or reduce such undesirable noises of brakes it is known to mount damping materials, for example damping plates or damping sheets on the brake linings, for example on a friction lining support plate of a brake lining. Undesirable noises can thereby be reduced.

Furthermore, regular attempts are made to change the geometries of the brake linings in order to further reduce noise developments.

### Presentation of the Invention: Object, Solution, Advantages

The object of the present invention is to make available a brake lining as cost-effectively as possible, by way of which these undesirable noises, in particular squealing, are not generated or can at least be significantly reduced.

This object is solved through a brake lining comprises a support body and a friction lining arranged on the support body, in that on or in the brake lining an actuator for generating a mechanical oscillation is arranged. By means of this mechanical oscillation, the undesirable noises, in particular the squealing, are reduced or completely avoided. According to the invention, the actuator in this case is designed in such a manner that it can be excited by an electrical signal.

The brake lining can be a lining for different brakes, for example disc brakes or drum brakes. The support body of the brake lining serves for receiving or for arranging the friction lining on the support body. The support body can for example be designed as a friction lining support plate. The friction lining is arranged on a first lateral surface of the support body, for example of the friction lining support plate. On the opposite lateral surface of the support body, i.e. on the lateral surface facing away from the friction lining, namely the second lateral surface, a damping plate is preferentially arranged. Such a damping plate is also called “shim”. The damping plate is preferably rigidly connected to the support plate. For example, the damping plate can be glued onto the support body or riveted to the same.

An actuator can also mean a transducer. The actuator in this case is designed so that based on excitation or activation a mechanical movement is created. The mechanical movement in this case is created in such a manner that a mechanical oscillation develops. Furthermore, the actuator is preferably designed for active activation and/or for open-loop activation. Active activation is to mean that the electrical signal for exciting or activating the actuator is specifically generated and applied to the actuator at a predetermined time and/or in a predetermined condition. For example, the actuator could be excited on falling below a certain speed and/or upon actuation of the brake. “Open-loop” actuation is to mean that the actuator is not used as sensor as well and consequently no measurement data is detected by the actuator. The electrical signal for exciting the actuator is generated independently of states in or on the brake lining or independently of states in the brake and applied to the actuator. Accordingly, the excitation of the actuator is preferably not dependent on values and/or states to be measured in the region of the brake lining.

Through the brake lining according to the invention, a brake lining with a device for avoiding or reducing noises, for example squealing in the brake can be made available particularly cost-effectively.

Preferably, the actuator comprises one or multiple piezo elements or consists of one or multiple piezo elements. Accordingly, it is preferably provided that the actuator is designed as a piezo actuator. The piezo actuator is based on the inverse piezo effect. Accordingly, the actuator is excited through inversion of the piezo effect. Excitation is effected by electrical voltage. Following the application of the electrical voltage, the piezo actuator generates a mechanical to and fro movement, as a result of which a mechanical oscillation is created. A piezo element comprises piezoelectric materials, for example piezoelectric crystals or piezoelectric ceramic materials.

One or multiple piezo elements preferably comprise a piezoelectric ceramic material and are thus preferably designed as piezo-ceramic element. Here it is preferably provided that all piezo elements of an actuator are designed as piezo-ceramic elements.

It is also preferably provided that the actuator is designed in such a manner that the same, when excited by means of an electrical alternating voltage and/or a noise signal, creates the mechanical oscillation with a frequency greater than 16 kHz. The noise signal is preferentially a narrow, broad-band noise. Here, the electrical voltage for exciting the actuator is preferably applied to the actuator in the form of an electrical alternating voltage and/or a noise signal. The actuator is thus preferably designed in such a manner that the same creates a mechanical oscillation with a frequency in the ultrasound range through excitation by means of an electrical alternating voltage and/or of a noise signal. For this purpose, the actuator can have a predetermined geometry, for example a predetermined thickness, width and/or length. Furthermore, for creating a mechanical oscillation in these preferred frequency ranges, the actuator can have predetermined material characteristics or material compositions and concomitant material constants such as for example speed of sound and/or natural frequency.

The actuator can have any suitable shape or geometry. Preferably, the actuator is designed as a flat element. In terms of the present invention, this is to mean that the actuator has a smaller thickness than length and width. The actuator can for example be designed cylindrical or cuboid.

Furthermore, the actuator is preferably designed as a layered structure with multiple layers. For this purpose, multiple piezo elements are arranged on top of one another, wherein between each two piezo elements an electrode is provided. Accordingly, a piezo stack is preferably provided. Accordingly, multiple piezo elements are arranged in a cascaded manner, wherein through the arrangement of multiple piezo elements on top of one another a mechanical series-arrangement of the piezo elements is created. The piezo elements arranged on top of one another are interconnected via the electrodes provided between each two piezo elements. Here, an electrical shunt connection is preferentially provided. Accordingly, all positive connections are preferentially connected and all negative connections are also connected. Through such a layered structure, greater amplitudes of the mechanical oscillation can be achieved with smaller voltages. Furthermore it is preferably provided that the layered structure or the piezo stack comprises a cladding, for example a ceramic cladding.

The actuator can be arranged in different places in or on the brake lining and connected to the brake lining. For example, the actuator can be arranged on or in the support body. Here it can be preferentially provided that the actuator is arranged on the first lateral surface of the support body and thus between the support body and the friction lining arranged thereon. For example, the actuator can be glued onto the support body and thus be connected fixed to the support body. Furthermore it is preferably provided that the actuator is integrated in the support body.

Furthermore, the actuator could be arranged on the lateral surface facing away from the friction lining, namely the second lateral surface, of the support body. When providing a damping plate, the actuator could thus be connected between support body and damping plate to the support body in a fixed manner.

In addition it is preferably provided that the actuator is arranged in or on the friction lining of the brake lining and connected to the friction lining. Here, the actuator can for example be arranged on a lateral surface of the friction lining assigned to the support body, for example glued on. Furthermore, the actuator could be integrated in the friction lining.

When a damping plate is provided, the actuator could alternatively be also arranged on the damping plate. Here, the actuator could be arranged, for example glued onto the lateral surface of the damping plate assigned to the support body. Furthermore, the actuator could be arranged, for example glued onto the lateral surface of the damping plate facing away from the support body.

Preferably, the actuator is arranged in the pressure region of a pressure means of a brake and on the brake lining. The pressure region of a pressure means of a brake is the region in which the pressure means acts on the brake lining when the brake is actuated. For example, the pressure means can be designed piston-like and substantially act on the second lateral surface of the support body in the middle or on a damping plate mounted on the second lateral surface of the support body. Here, the actuator can be arranged in such a manner that the same directly comes into contact with the pressure means when the brake is actuated. This is the case for example when the actuator is mounted on the second lateral surface of the support body or on a lateral surface of a damping plate facing away from the support body.

On or in the brake lining, preferably connection elements for electrically connecting the actuator with a control system are arranged. The connection means can for example be designed as wires or cables. Preferably, two connection means for contacting the electrodes which are connected to the actuator are provided. The connection means, for example wires or cables can be fastened to the support body for example glued to the same. Furthermore, the connection means can be arranged on the damping plate and fastened to the same. The connection means could also be arranged on a lateral surface of the friction lining facing the support body and connected with the same. Alternatively, the connection means could project into the friction lining and could thus be connected to an actuator integrated in the friction lining. The control system can be integrated in the vehicle, for example in the system electronics of the vehicle. The control system could also be linked to a brake light activation of the vehicle. The control system is designed for actively activating or for actively creating the electrical excitation of the actuator.

The actuator is preferentially connected to an electrode each on two lateral surfaces located opposite one another. The connection means serve for contacting these electrodes and for electrically connecting this electrode to the control system. Consequently, the actuator is connected to the control system via the electrode and the connection means. Alternatively, the connection elements can comprise the electrodes. For example, a wire end could also be designed as a connection electrode.

According to the invention, a brake comprising a brake lining according to the Claims 1 to 8 is furthermore provided. The brake can be designed as a disc brake or drum brake.

Furthermore, a control system for actively activating an actuator is provided according to the invention. Here, the actuator is arranged in or on a brake lining according to any one of the Claims 1 to 8.

The object is solved furthermore through a method for reducing noises of a brake in that an actuator arranged in or on a brake lining according to any one of the Claims 1 to 8 is actively activated by means of an electrical voltage. Actively activating is to mean specific excitation of the actuator under predetermined conditions for generating the mechanical oscillation. Predetermined conditions can mean for example falling below a predetermined speed and/or the actuation of a brake.

Activation or excitation of the actuator is preferably carried out as open-loop activation. This is to mean that no measurement values are detected by the actuator. Consequently, a particularly cost-effective method for the noise reduction in a brake can be made available. The mechanical oscillation of the actuator in the predetermined frequency range, for example in the ultrasound range, can completely prevent or at least significantly reduce squealing. Consequently, measuring or detecting values in the brake or in the region of the brake lining by using the actuator as a sensor is not mandatorily required for generating the activation signal or the excitation.

### BRIEF DESCRIPTION OF THE DRAWINGS

It shows schematically:

FIG. 1 a perspective view of a brake lining,

FIG. 2 an actuator as piezo element,

FIG. 3 an actuator as layered structure of multiple piezo elements, and

FIG. 4 a brake lining arranged in a brake with actuator and control system connected therewith.

### PREFERRED EMBODIMENTS OF THE INVENTION

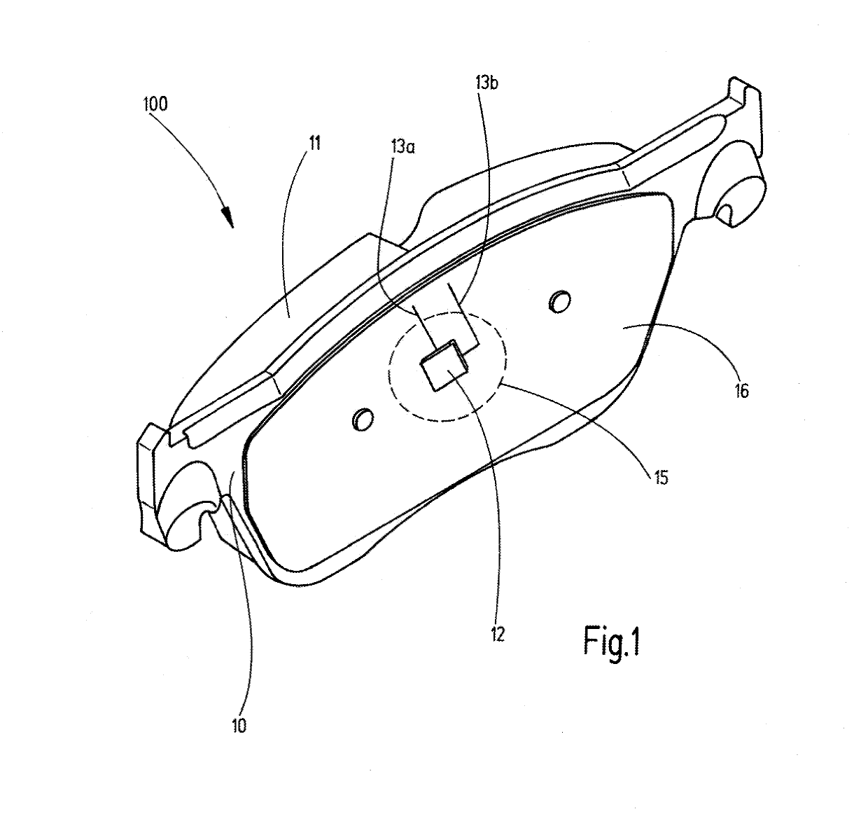

FIG. 1 shows a perspective view of a brake lining 100. The brake lining 100 comprises a support body 10 in the form of a friction lining support plate and a friction lining 11 arranged on a first lateral surface of the support body 10. On the lateral surface facing away from the friction lining 11, namely the second lateral surface, of the support body 10 a damping plate 16 is arranged and connected fixed to the support body 10.

On the damping plate 16, an actuator 12 in the form of a piezo element 18a is arranged. The piezo element 18a in this case is glued onto the damping plate 16. Via connection elements 13a, 13b, the piezo element 18a is connected to a control system 300 (not shown in FIG. 1).

The actuator 12 in this case is designed as piezo element 18a in such a manner that upon excitation by means of an electrical alternating voltage and/or of a noise signal the piezo element 18a is mechanically oscillated, or a mechanical oscillation is created by the piezo element 18a, as a result of which the squealing of the brake 200 (not shown in FIG. 1) can be avoided or at least significantly reduced. To this end, the piezo element 18a is designed in such a manner and is activated by means of the electrical alternating voltage and/or of a noise signal in such a manner that through the piezo element 18a a mechanical oscillation with a frequency in the ultrasound range is created.

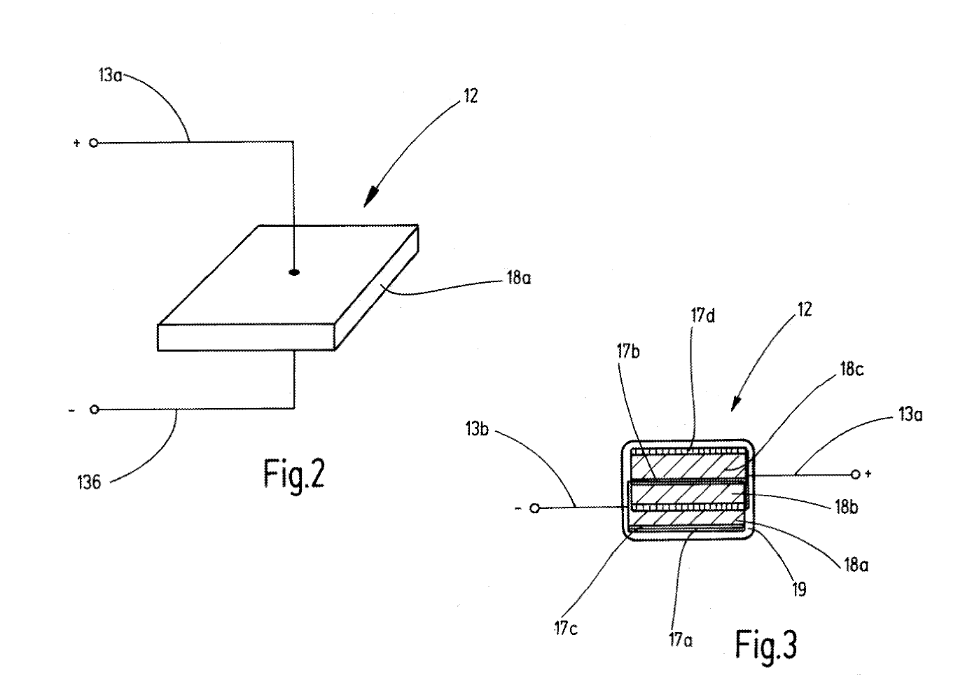

FIGS. 2 and 3 show possible configurations of an actuator 12. In FIG. 2 it is shown that an actuator 12 can be designed for example from a piezo element 18a that is designed flat. The connection elements 13a, 13b can be connected to the outer surfaces of the piezo element 18a via electrodes 17a, 17b, 17c, 17d. When the piezo element 18a is excited by means of an electrical signal, namely an electrical alternating voltage and/or of a noise signal, a mechanical movement and mechanical oscillation resulting from this is created because of the inverted utilisation of the piezo effect.

In FIG. 3 an actuator 12 is shown, which is designed from a layered structure of a cascading of multiple piezo elements 18a, 18b, 18c. To this end, a first piezo element 18a is placed onto a first electrode 17a or arranged thereon. On the first piezo element 18a, a second electrode 17c is arranged. Thereon, in turn, a further piezo element 18b is arranged. On the further piezo element 18b a third electrode 17b and thereon a third piezo element 18c is arranged. Finally, a fourth electrode 17d is arranged on the third piezo element 18c.

The entire layered structure is clad by means of a ceramic cladding 19. By means of the electrodes 17a, 17b, 17c, 17d the piezo elements 18a, 18b, 18c are electrically connected to one another. Here, the electrodes 17a, 17b, 17c, 17d are connected to one another in an electrical shunt connection. Each two of the electrodes 17a, 17c are connected to a first connection element 13b and the two other electrodes 17b and 17d to a second connection element 13a. The layered structure could also have more than three piezo elements 18a, 18b, 18c.

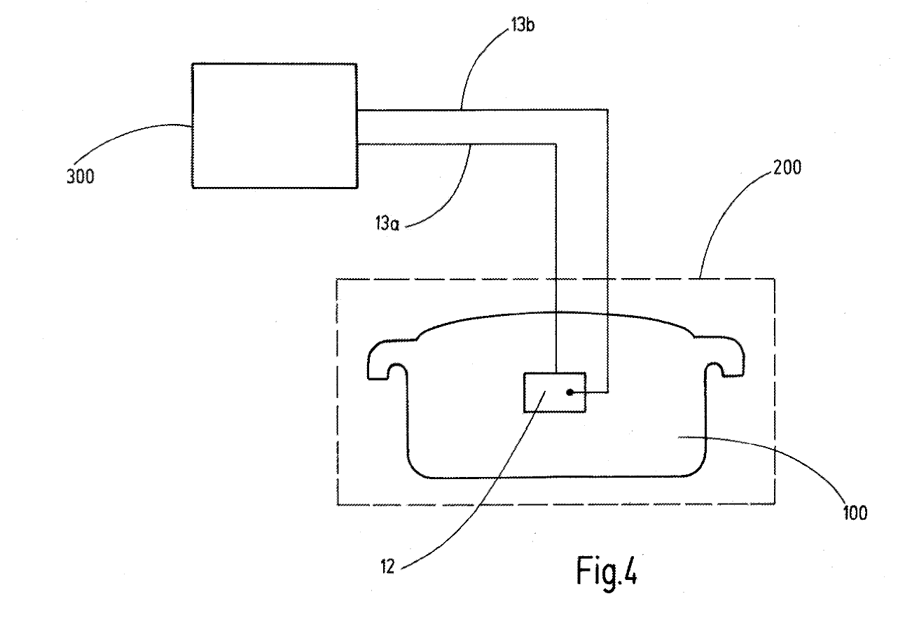

FIG. 4 shows a schematic representation of a brake lining 100 arranged in a brake 200 with actuator 12 arranged thereon. The actuator 12 is connected to a control system 300 via connection elements 13a, 13b. By way of the control system 300, the actuator 12 is excited for example activated by means of an electrical signal.

1. A brake lining comprising a support body and a friction lining arranged on the support body, characterized in that for noise reduction by means of a mechanical oscillation on or in the brake lining, an actuator for creating the mechanical oscillation is arranged, wherein the actuator can be excited by an electrical signal.

2. The brake lining according to claim 1, characterized in that the actuator comprises a piezo element or multiple piezo elements or consists of a piezo element or of multiple piezo elements.

3. The brake lining according to claim 2, characterized in that a piezo element comprises a piezoelectric ceramic material or in that multiple piezo elements comprise a piezoelectric ceramic material.

4. The brake lining according to claim 1, characterized in that the actuator is designed in such a manner that the same when excited by means of an electrical alternating voltage and/or of a noise signal creates the mechanical oscillation with a frequency greater than 16 kHz.

5. The brake lining according to claim 1, characterized in that the actuator is designed as a layered structure with multiple layers, wherein multiple piezo elements are arranged on top of one another and wherein between each two piezo elements an electrode is arranged.

6. The brake lining according to claim 1, characterized in that the actuator is arranged on or in the support body and/or on or in the friction lining and/or on a damping plate that is rigidly connected to the support body.

7. The brake lining according to claim 1, characterized in that the actuator is arranged on the brake lining in a pressure region of a pressure means of a brake.

8. The brake lining according to claim 1, characterized in that on or in the brake lining connection elements for electrically connecting the actuator to a control system are arranged.

9. A brake for a vehicle, characterized in that the brake comprises a brake lining according to claim 1.

10. A control system for actively activating and actuator, characterized in that the actuator is arranged in or on a brake lining according to claim 1.

11. A method for reducing noises of a brake, characterized in that an actuator arranged in or on a brake lining according to claim 1 is actively activated by means of an electrical voltage.

12. The method according to claim 11, characterized in that the actuator is activated by means of an electrical alternating voltage and/or of a noise signal, wherein the electrical alternating voltage and/or the noise signal has a frequency which substantially corresponds to the natural frequency of the actuator or a harmonic of this natural frequency.

13. The method according to claim 11, characterized in that the activation is carried out as open-loop activation, during which no measurement values are detected by the actuator.
